(19) United States
(12) Patent Application Publication
(10) Pub. No.: US 2007/0297755 A1
(43) Pub. Date: Dec. 27, 2007

(54) PERSONALIZED CUTLIST CREATION AND SHARING SYSTEM

(76) Inventors: Russell Holt, Philadelphia, PA (US); Srinivas Balijepalli, Philadelphia, PA (US); Andreas Richter, Wynnewood, PA (US); Evans Krauss, Redwood City, CA (US)

Correspondence Address: DALINA LAW GROUP, P.C., 7910 IVANHOE AVE. #325, LA JOLLA, CA, 92037, US

(21) Appl. No.: 11/756,592

(22) Filed: May 31, 2007

Related U.S. Application Data
(60) Provisional application No. 60/810,005, filed on May 31, 2006.
(60) Provisional application No. 60/818,715, filed on Jul. 5, 2006.

(51) Int. Cl. H04N 5/93

(52) U.S. Cl. 386/52

(57) ABSTRACT

Plays videos in conjunction with a “cutlist” utilized to modify the video. Videos include any visual media such as online or streaming video, broadcast television or movies, digital media files having a video component or DVDs. The videos may originate from any location such as online, on YOUTUBE.COM®, cable television, or a local resource such as a digital media file or DVD. Cutlists may include “mashups” and “cuts”. Mashups add content and include additional user generated input such as text, audio, commentary, graphics, avatar overlays, advertisements or other video. Cuts allow skipping of video and are time windows or scenes that are not to be viewed. The modified video may be viewed on any device associated with a video display. Cutlists may be shared among users to modify the performance of original video source without modifying the video itself, therein bypassing any copyright issues.

This application takes benefit of both U.S. Provisional patent application Ser. No. 60/810,005 filed 31 May 2006 and U.S. Provisional patent application Ser. No. 60/818,715 filed 5 Jul. 2006, the specifications of which are both hereby incorporated herein by reference.

### BACKGROUND OF THE INVENTION

1. Field of the Invention

Embodiments of the invention relate to computer systems and more specifically, but not by way of limitation, provide a new way to watch video wherein a video presentation can be augmented with text, sound or visual elements and/or edited so that unpleasant or undesired scenes can be skipped while watching the video and wherein a cutlist associated with the video may be shared between users without copying the video.

2. Description of the Related Art

Current videos as viewed online for example online, for example on YOUTUBE.COM® or on mobile devices or televisions, for example as played from a DVD, would benefit from additional user generated commentary, sounds or graphics. In addition, current videos may also contain scenes that may or may not be appropriate for certain viewing audiences. For example, many videos today have violence and language that is inappropriate for certain aged viewers. Unfortunately, there are no known solutions that allow for augmenting an online, broadcast, streaming or other type of copyrighted video wherein the augmented material and deleted scenes, i.e., “cutlist” can be shared among users to modify the performance of original video source without modifying the video itself. Currently solutions are only centered around creating a complete video output based on multiple media inputs. The entire video that is generated is distributed as a monolithic media file or stream to end users regardless of whether the generated video contains copyrighted material.

Currently, when watching network television or a DVD, many scenes are edited out of the video that contain objectionable material, however the television networks and DVD creators are in control of what scenes are edited for a particular audience. In many cases, unobjectionable scenes are edited out or random scenes are edited out to ensure that the video conforms to the time constraints of the slot in which the movie is to be shown. This renders many movies in a less than desirable form than originally intended. Certain scenes may also be deleted for certain regions as well, hence a DVD for a particular region may or may not include a region-specific objectionable scene for example.

There is currently no known system that allows for personalized control of the material to add or scenes to be cut from a video so that augmented media is shown or non-desired scenes are not shown during the performance of a movie without modifying the video itself. This presents copyright issues in that the owners of the video may not desire modified versions of their creation to be copied and altered. Hence, there is a need for a personalized cutlist creation and sharing system that allows users to create a cutlist that may be shared separately from the original video.

### BRIEF SUMMARY OF THE INVENTION

Embodiments of the invention provide a player that plays videos in conjunction with a “cutlist” that is utilized to modify the video. Videos may include any visual media such as online video, streaming video, broadcast television or movies, digital media files having a video component or DVDs for example. The video may originate from any location such as online, for example on YOUTUBE.COM® or from cable television, or a local resource such as a digital media file or DVD. Cutlists may include “mashups” and “cuts”. “Mashups” may be created to add content to a video and include additional user generated input such as text, audio, commentary, graphics, avatar overlays, advertisements or other video. Mashups may access content from the web, a user's own computer, a DVD, or any other medium. In addition, cutlists enable the skipping of scenes via “cuts”. Cuts in videos are time windows or scenes that are not desired or that may not be appropriate for certain viewing audiences. Thus, video may be modified via the player including augmented material, i.e., “mashups” and without deleted scenes, i.e., “cuts” as directed by the cutlist. The modified video may be viewed on any device associated with a video display such as a computer, mobile computing device, DVD player, cable set top box, digital video recorder (DVR), video on demand (VOD) unit, video game console.

Cutlists may be shared among users to modify the performance of original video source without modifying the video itself, therein bypassing any copyright issues. The cutlist may be accepted by the system for upload to a website. The cutlist may be searched, viewed, rated, browsed or found in any other manner from the website. Alternatively, the cutlist may be shared between players in any other manner such as via BlueTooth® or email for example. The cutlist, one downloaded via the system allows for an associated video to be played in a modified manner as defined by the cutlist. Since the cutlists do not include the copyrighted content for augmenting a video, the copyright issue is eliminated. In addition, the website may host groups and allow users to join groups, for example along with users of similar interests. Embodiments of the invention place end users in control of the performance of a video including additional media, and with or without particular scenes.

A typical user of an embodiment of the invention can utilize the website for example to:
“Search” for a movie that they want to watch in edited form in the case of non-copyright video material that is closely coupled with a cutlist to form an integrated or new video.
“Search” for new cutlists by an author they enjoy or have been referred to as a good source of cutlists and play a cutlist along with a video.
“Browse” for a cutlist by category, rating or tag.

Once a user selects a cutlist, a player launches in at least one embodiment and the user is able to watch the modified video. The client may utilize any type of computer such as a Mac® or Windows® computer, or any other type of computer for example. One embodiment of the invention creates cutlists that work in conjunction with DVD players and digital media such as FLASH®, Windows Media® or any other digital video file format. Another embodiment of the invention creates cutlists that work in conjunction with streaming video over IP. Regardless of the type of video transport or operating system utilized, embodiments of the invention intercept the video data and apply mashups and cuts as per the cutlist. In one embodiment, the amount of time that all of the cuts sums to is utilized as an offset to play a real-time video broadcast, for example a television show. In this embodiment, a particular user may post a cutlist having cuts for the commercial breaks for a TV show. In this embodiment, other users may download the cutlist and start watching the TV show without commercials. In non-real-time broadcasts, the cuts may be merely skipped by directing a command to the DVD player or computer to skip ahead by the amount of time designated by the cut.

The player may in at least one embodiment of the invention utilize a computer based media player in conjunction with one of the following DVD Decoders:
Windows Media Player®, available from MICROSOFT®
Sonic CinePlayer® DVD Decoder, available from Sonic Solutions, Novato, Calif.
InterVideo WinDVD, available from InterVideo, Inc., Fremont, Calif.
CyberLink Power DVD, available from CyberLink Corp., Hsin-Tien City Taipei Hsien, Taiwan, R.O.C.
nVIDIA PureVideo Decoder available from nVIDIA Corporation, Santa Clara, Calif.

In edit mode, the system accepts a user modification input such as a mashup or cut for example. The system uses the user modification input to generate a cutlist. The cutlist hence allows a user to skip a portion of the video, mute, hide the video or show or hide a subtitle or text for example. The system accepts uploads, presents cutlists and provides downloads of the authored cutlist in web based embodiments of the invention.

Embodiments of the invention may work in conjunction with a variety of revenue models and the player also may play advertisements depending on the revenue model employed:
First, advertising on the site and advertising that precedes the playing of a video with a cutlist may be sold. Video ads carry a premium, but cuts can command an even greater return because the advertising being delivered can be completely targeted using the demographic profile of the users, and the content being watched, are both known. For example, a toy company may pay a heavy premium for placing a 10 second advertisement at the beginning of a Disney children's movie. Ads can also be placed within the video playback window. These can be set up to play at a specified time during video playback and at a predetermined location on the screen. For example, a pair of shoes that are shown in the movie can have link to a retailer that sells the shoes. Advertisement information may be displayed directly on the screen and/or there may be a link so the user can click on this ad to get access to additional information from the advertiser.
Second, users may be charged a subscription fee. This allows for flat rate monthly revenue generation regardless of the number of cutlists that a user downloads.
Third, cuts may enable a royalty payment, charging users to access premium video content that they need to view a selected cut and passing along that fee to the content owner.
Fourth, the company may earn affiliate revenue by linking to the purchase of DVDs or online content, for example through an on-line store or music delivery service, such as AMAZON.COM® or ITUNES®.

### BRIEF DESCRIPTION OF THE DRAWINGS

The above and other aspects, features and advantages of the invention will be more apparent from the following more particular description thereof, presented in conjunction with the following drawings wherein:

FIG. 1 shows an architectural view of the system.

FIG. 2 shows a view of an embodiment of the player.

FIG. 3 shows a view of an embodiment of the optional editor splash window.

FIG. 4 shows a view of an embodiment of the editor sound window.

FIG. 5 shows a view of an embodiment of the editor captions window.

FIG. 6 shows a view of an embodiment of the editor skip loop window.

FIG. 7 shows a view of an embodiment of the cutlist host.

FIG. 8 shows the upper half of the entity relationship diagram (ERD) utilized by an embodiment of the cutlist host, for example a website.

FIG. 9 shows the lower half of the entity relationship diagram utilized by an embodiment of the cutlist host.

FIG. 10 shows an embodiment of the method of the playing process for combining an external video source with a cutlist.

FIG. 11 shows an embodiment of the method of the system for playing, editing and accessing cutlists.

### DETAILED DESCRIPTION OF THE INVENTION

A personalized cutlist creation and sharing system will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

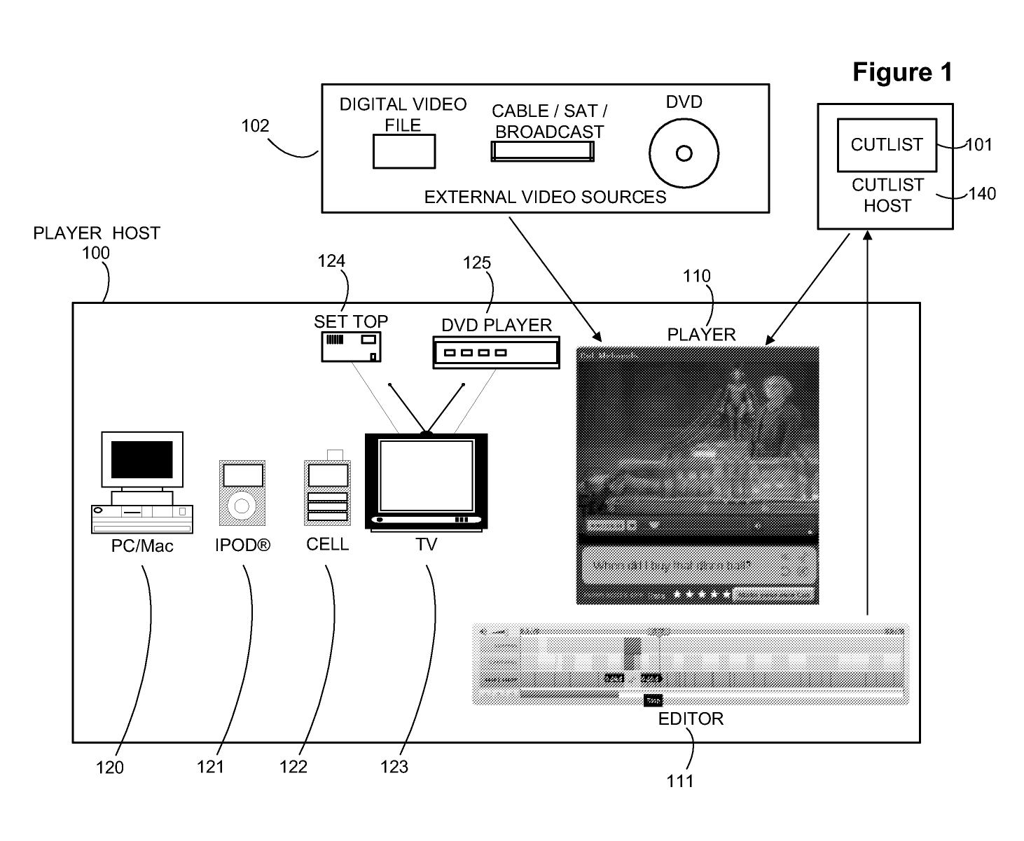

FIG. 1 shows an architectural view of the system. Player host 100 hosts Player 110 and optionally editor 111. Player 110 is presented to a user and accepts a video input selection from external video sources 102. External video sources 102 may include any source of video such as a digital video file which may be streamed or downloaded without streaming as hosted on an external website such as YOUTUBE.COM®. External video sources 102 may also includes files local to player host 100 such as a local file or link to a video. Furthermore, external video sources 102 may be a broadcast movie or television program as broadcast over cable, satellite or via radio waves. Player 110 also accepts a selection of cutlist 101 as hosted on cutlist host 140 or local to player host 100. In one or more embodiments of the invention, the cutlist refers to the video that is associated with the cutlist, so the system may automatically perform the video input selection without further user interaction. Player 110 plays modified video as per the instructions in cutlist 101 and shows the modified video on player host 100. Player host 100 may include any device coupled with a video display such as PC/Mac or any other computer 120, MP3 player 121 for example IPOD® or ZUNE®, cell phone 122, television (TV) 123, set top box 124 or DVD Player 125 for example. Set top box 124 may be implemented via a digital video recorder (DVR), video on demand (VOD) unit, video game console or any other type of television coupled device. By utilizing external video sources 102 as modified by cutlist 101, modified video is displayed without requiring the hosting of external video sources 102 themselves. Any device capable of executing logic may be utilized as player host 100. For example, for a broadcast television event set top 124 or television 123 (if configured with a programmable computer) may be utilized to host player 110. Likewise for external video source such as a streaming video hosted on a remote website, any device such as PC/Mac or any other computer 120 may host player 110.

Editor 111 may optionally execute on player host devices types 120-125 given that the particular device has a programmable logic computer capable of executing player 111. Editor 111 accepts a user modification input from the user, such as a mashup or cut (which may include skips or loops) and generate cutlist 101.

Cutlist 101 generated via editor 111 may be accepted for upload by the system to cutlist host 140 or optionally may be held on player host 100. If uploaded, the cutlist may be presented to other users via a website for example. Once presented, other users may download cutlist 101 via the system onto their own player host 100, which may be any type of device capable of hosting player 110.

The selection of video is accomplished as the system accepts a URL, path, channel selection or any other indication as to the location of external video source 102. In one or more embodiments of the invention, the player may automatically detect the insertion of a DVD for example as an indication that as to which source to utilize. Any other method of indicating the particular external video source to use is in keeping with the spirit of the invention.

The system accepts user modification inputs that include mashups and cuts. Mashups may include text input, audio input which may include user supplied audio such as commentary or stock audio, graphic input of any type including balloons, drawings, or any other type of graphic. In addition, the mashup may include a second video or avatar overlay such as a graphical representation of an individual. Mashups may also include advertisements, and the advertisements may be utilized for example as substitute advertisements to substitute for the advertisements of a broadcast for example. This allows for advertisements to directly target the user viewing player 110 when player host accepts user preferences for example. Cuts may include skips which are time blocks that designate the portion of a video to skip or may include loops that allow for a particular portion of the video to be replayed any number of designated times.

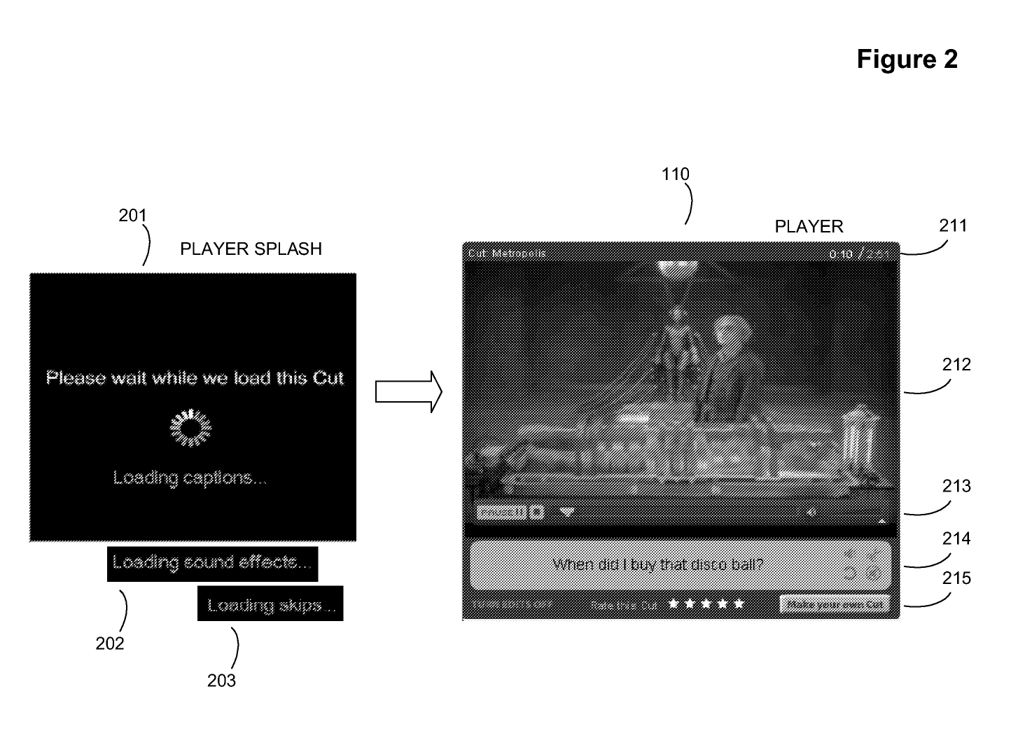

FIG. 2 shows a view of an embodiment of the player. Player splash 201 is optionally shown in player 110 after a cutlist is selected as indicated by the empty arrow between player splash 201 and player 110. Player spash 201 may show any cutlist related loadings, such as loading sound effects 202, skips 203 or any other mashup or cut related item. Player 110 includes optional title bar 211 that may include the title and a time indicator for example that shows the amount of time into the video and total time. Player 110 includes modified video display 212 which shows the modified video. Player controls 213 may optionally show when a cursor for example moves over modified video display 212. Player controls 213 may optionally include a play/pause button, record button, time line slider and audio volume control as shown left to right, or may include any combination of these items thereof. Player 110 optionally includes caption area 214, although in one or more embodiments of the invention, text may be shown as part of graphics anywhere in modified video display 212. Player 110 optionally includes control area 215 that for example may include a “turn edits off” control, a rating control or an invoke editor control as shown left to right.

A DVD specific embodiment allows for integration with a computer or DVD player having programmable capabilities. In this embodiment, if the meta data (information available from the DVD itself such as Volume Name, Version, Region, TitleChapterString, FrameRate, ID, etc.) associated with the DVD in a user's DVD drive matches meta data that is in the cutlist host or database, then the video detail or cutlist page is displayed for that DVD. This may include presenting a list of possible cutlists that have already been created for the movie. The cutlists may include authors that have rankings or are referred to the viewer. The cuslists may be searched or browsed to find a particular cutlist that suites the viewing characteristics of the viewer.

Any advertisements associated with the cutlist play either before, during, or after playback of a movie. The advertisements may play in lieu of advertisements associated with the external video, for example to target ads at a particular viewing audience. The player downloads and plays advertisements from integrated with the cutlist external to the cutlist, for example from a URL.

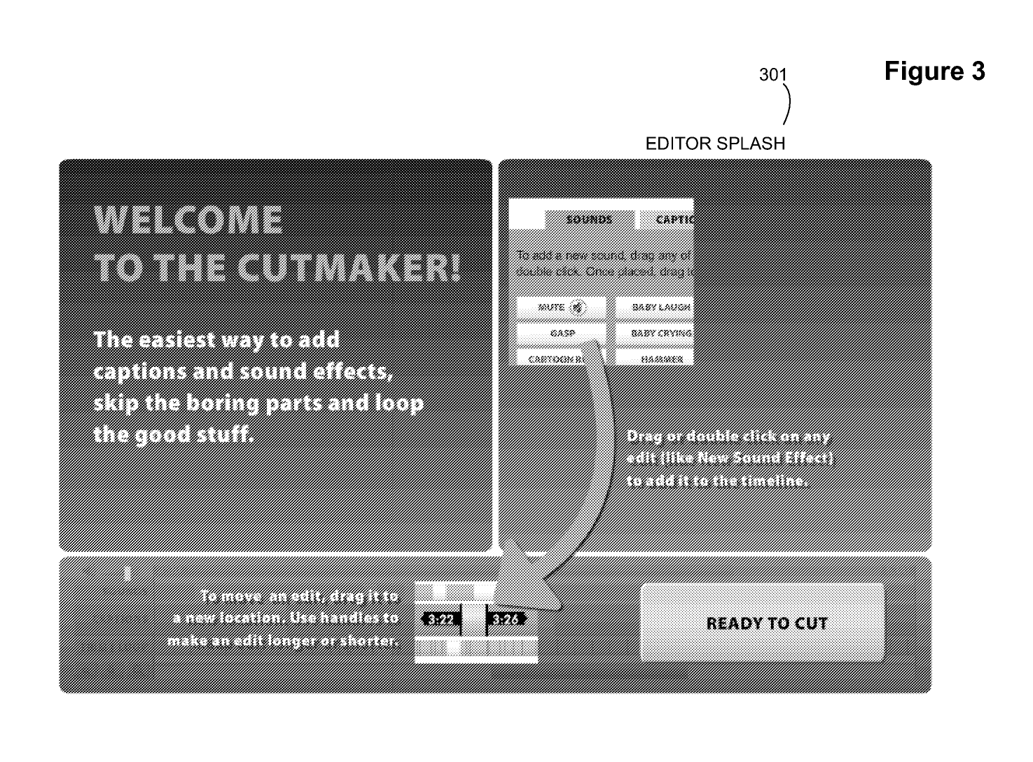

FIG. 3 shows a view of an embodiment of optional editor splash window 301. This window may be displayed to indicate the method of asserting mashup elements at particular time offsets for example. This window may not be shown for users already familiar with the edit process for example.

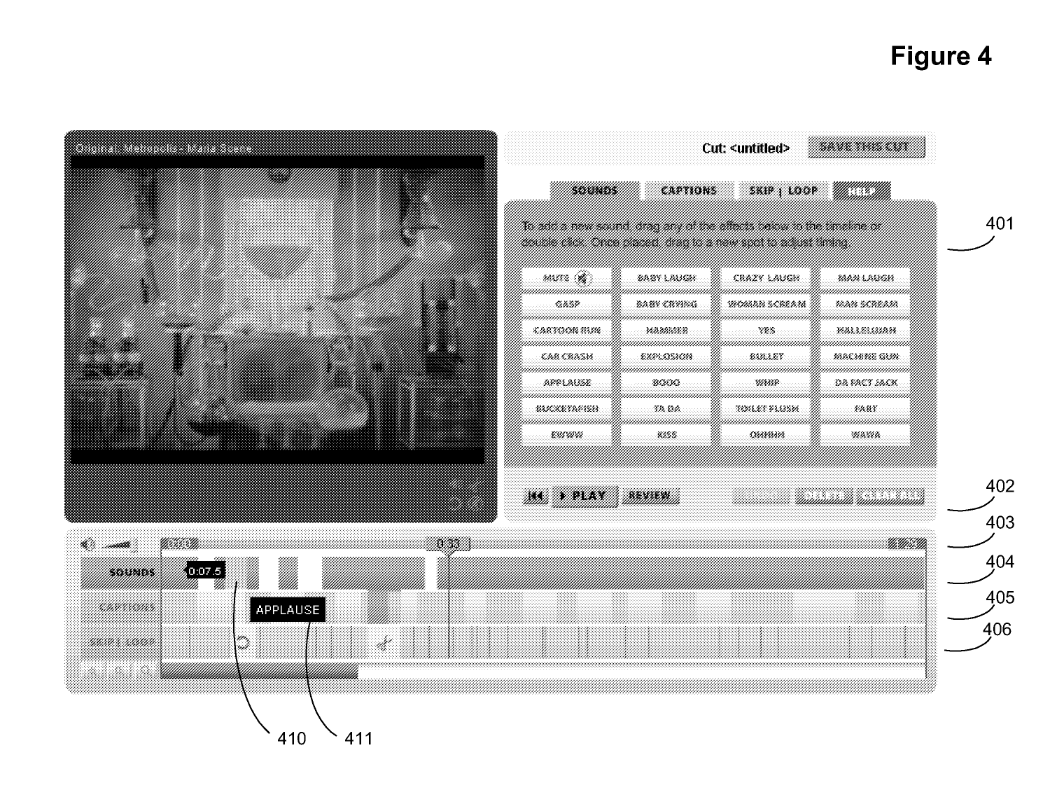

FIG. 4 shows a view of an embodiment of the editor sound window. Sounds selection area 401 contains sounds available for mashup. Alternatively, a user may record their own sound and insert the sound onto sound timeline 404. By dragging or in any other manner asserting the particular sound 410 to include on sound timeline 404, the sound is played at the designated time (as shown with offset to start just to the left of sound 410). Optionally, text indicator of the sound name 411 may be shown when the sound is inserted or on mouse-over for example. In addition, optional control section 402 may be utilized to control the playing of the video as modified by the user inputs and may also allow for deleting mashup elements or undoing inserts for example. Timeline 403 shows the current time point (0:33 as shown) and the total length of the external video (1:29 as shown). Caption timeline 405 and cut timeline 406 for scheduling skips and loops will be described below.

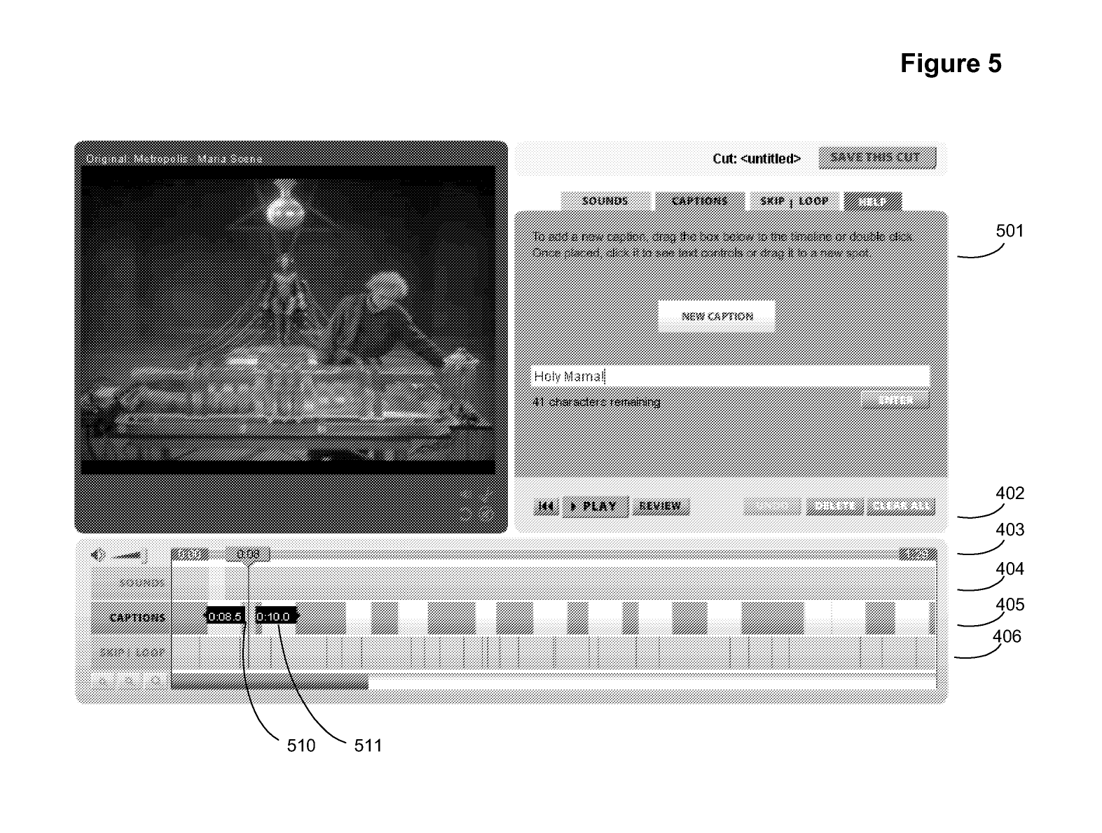

FIG. 5 shows a view of an embodiment of the editor captions window. Captions window 501 may be utilized to enter any text to play with the external video. Once entered, the caption is placed along caption timeline 405. The start point and duration of the caption display is shown as caption block 510 and offsets to other captions are shown to the left and right of caption block 510 at offset indicators 511.

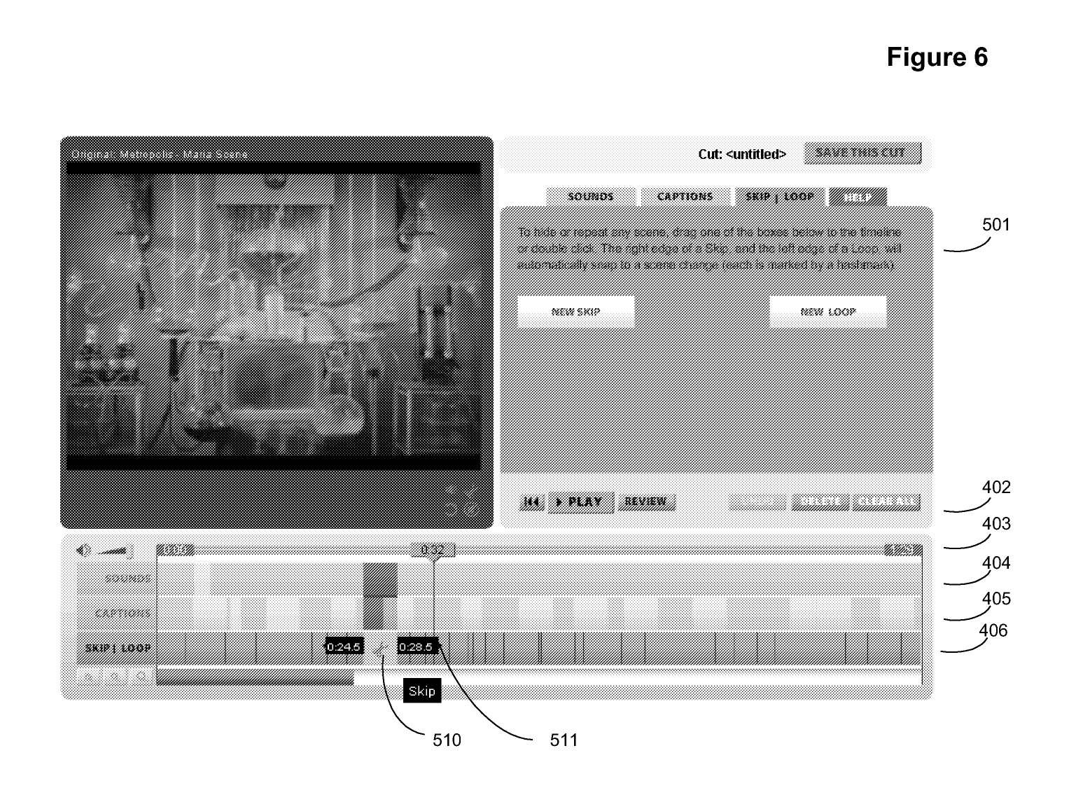

FIG. 6 shows a view of an embodiment of the editor skip loop window. Loop 610 is shown as looping 2 times from time offset “0:08.0” to “0:110”, skip 611 is a type of cut that skips video. Scenes change bars 612 are displayed to shown possible scene changes to aid in the placement of skip and loop type cuts.

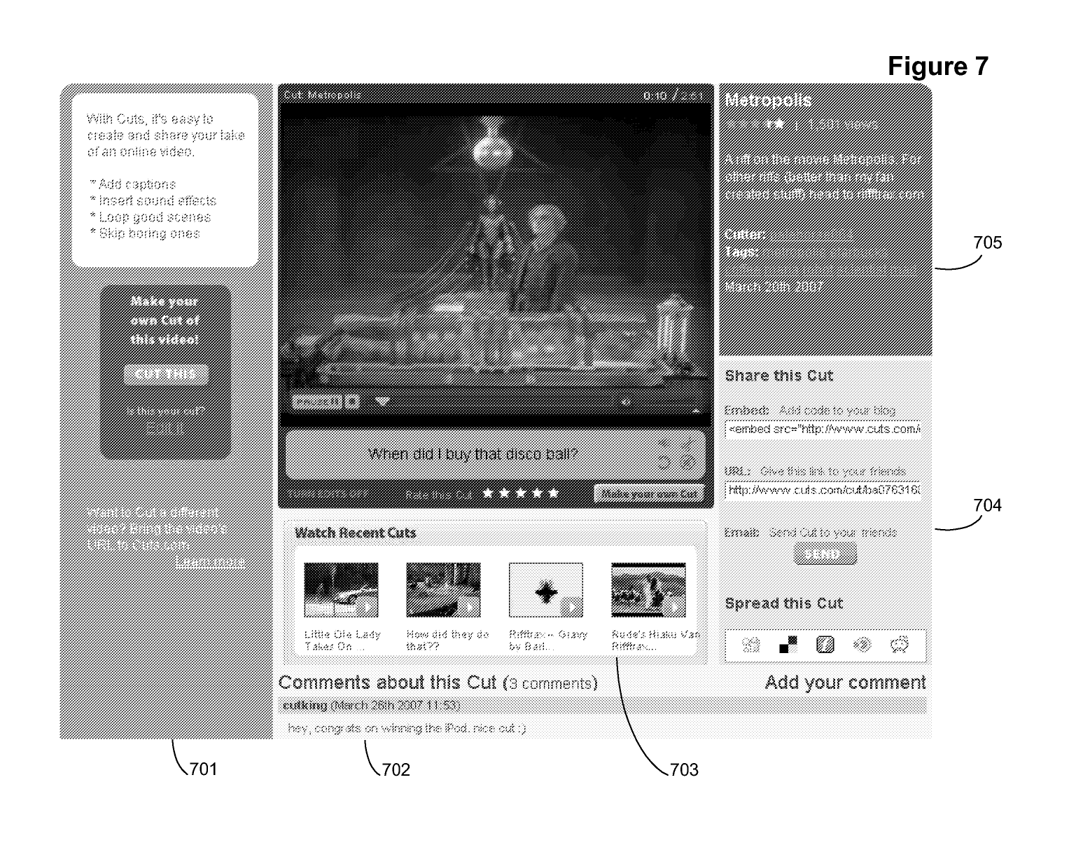

FIG. 7 shows a view of an embodiment of cutlist host 140. Cut control area 701 allows for apply a new cutlist to an external video or editing another cutlist as created by another user. Comment area 702 allows for other users to comment on the modified video (also known as a “cut”). Selection area 703 allows for viewing other cultists. Share area 704 allows for selection of markup to utilize in sharing the cutlist with other users. Information area 705 shows information related to the cutlist such as the person who made the cutlist, i.e., the “cutter” and information related to the external video.

A website enabled embodiment of the invention may form a portion of cutlist host 140. The website for example may other search tools in addition to selection area 703. For example, in one or more embodiments search may be conducted by title, cutlist, cutter, tag or any other metadata associated with a movie or cutlist. The system may also provide a browse mechanism that allows for alphabetical or ratings based browsing including for example latest cutlist uploads. Any type of authorization may be utilized by the website including none. Group based operations may also be utilized to form groups of users with similar interests for example. Users may also tag cutlists to provide search phrases that allow for easier categorization or searching of particular cutlists. The system also provides options for rating cutlists while watching the modified video for example.

One or more embodiments of the invention are implemented with AJAX (Asynchronous JavaScript and XML) popups appear throughout the site. They provide additional information to the user without forcing page reloads. On mouse over of <video/content name> a popup may be displayed having the following information, for example movie title (release year in parenthesis), contributors (max 2), genre, cover art. In addition, on mouse over of cutlists, the popup may display rating, cutter, cutter rating, description of cutlist and cutlist tags.

One embodiment of the website help page provides the following directions:

How do I bring a video?

It's easy. All you need is the URL of the video's page. To get the URL . . .
1) Open a new browser page
2) Navigate to the video community site (i.e. YouTube®, MySpace®) that hosts the video you are interested in (see list of sites we enable)
3) Go to the page that plays the video you want to Cut
4) Copy the page's URL from your browser's address bar
NOTE: many video community sites offer you the means to share the video you are watching by sending your friends an URL—this is likely the same same URL that you would bring (for example: http://www.youtube com/watch?v=C4kxS1ksqtw)
5) Paste the URL into the Bring a Video section
6) Click Cut This

What sites can I bring a video from?

Currently we support URLs from the following sites:
YouTube™
MySpace™
Google®
This list will be regularly updated.
This website does not store or host any videos. All videos are provided courtesy of other websites. If you wish to cut your own video, you need to host it on one of the above video community or hosting sites and come back with the URL.

Besides the sites whose URLs you support, are there other sources of video that I can cut?
You can cut any online video if you know its FLV URL. Sites like Blip.tv® provide direct access to these URLs (example: http://blip.tv/file/get/Pritchard-whoisthatguy.flv). To learn more about other sites that provide URLs in this format, click here.

Does the cutlist website have videos that I can work with to create my own cut?
You can take any cutlist and make your own cutlist of the same video. To get started, watch a few cutlists, pick the one you want to work with and click Cut This. Or you can bring your own video.

I have my own video, how can I upload it?
There are plenty of sites that do this well, so we haven't focused on this. If you have a specific video that you would like to cut, you should first upload it to one of the sites whose URLs we support (see list) and then.
1) Bring a video learn more
2) Make a Cut learn more
3) Share your Cut learn more

Once I press “Cut This”, what's going to happen?
The video will start to stream into the editor, i.e., CutMaker—this may take a few moments to complete as it depends on your connection speed and the video community site's network. Once the video starts to load, the CutMaker will open and you can make your cutlist.

What does “Video cannot be displayed” mean?

There are a number of potential reasons.
If the link is from a video community site that we have not yet enabled, then we suggest that you search for the same video on one of the sites we do support (see list) and bring that video back.
If the link is from a video community site that we do support, they may have taken the video down. So check on the site to be sure that the video is still available, if it is, try again.

What is the “Cut It” tool?

It simplifies the process of Bringing a Video.
Simply drag the “Cut it! ” link below into your browser's bookmarks bar. The next time you are on the page of video you want to cut, just click on the bookmarklet and we will automatically bring the video to the CutMaker. Its that easy.

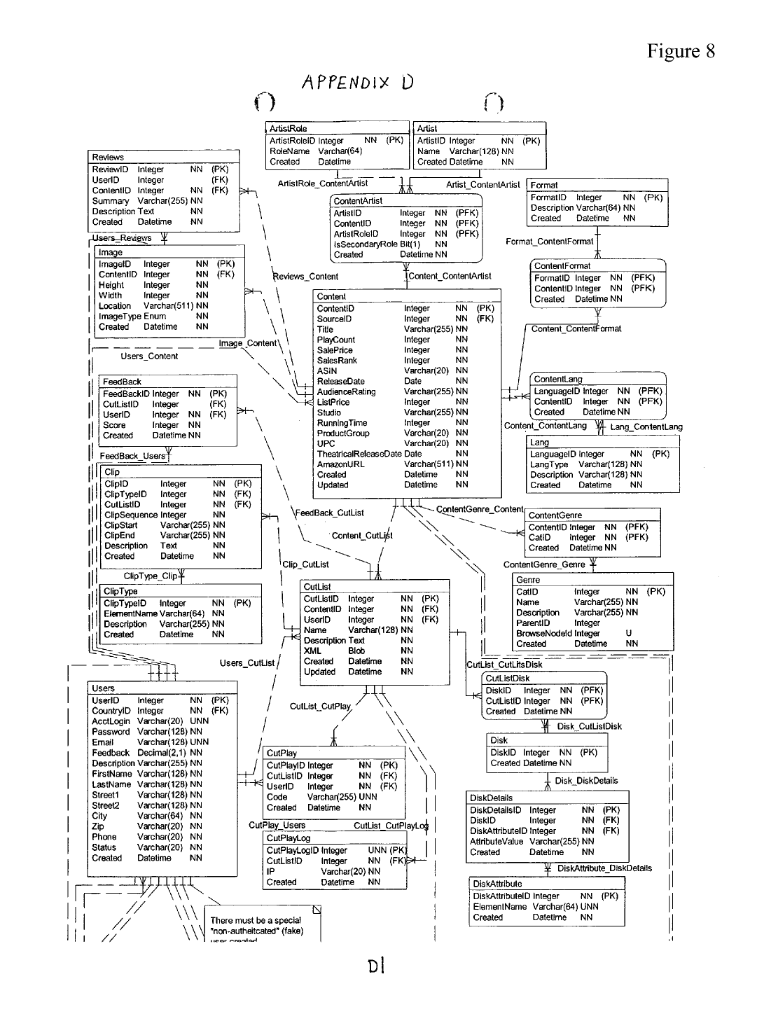

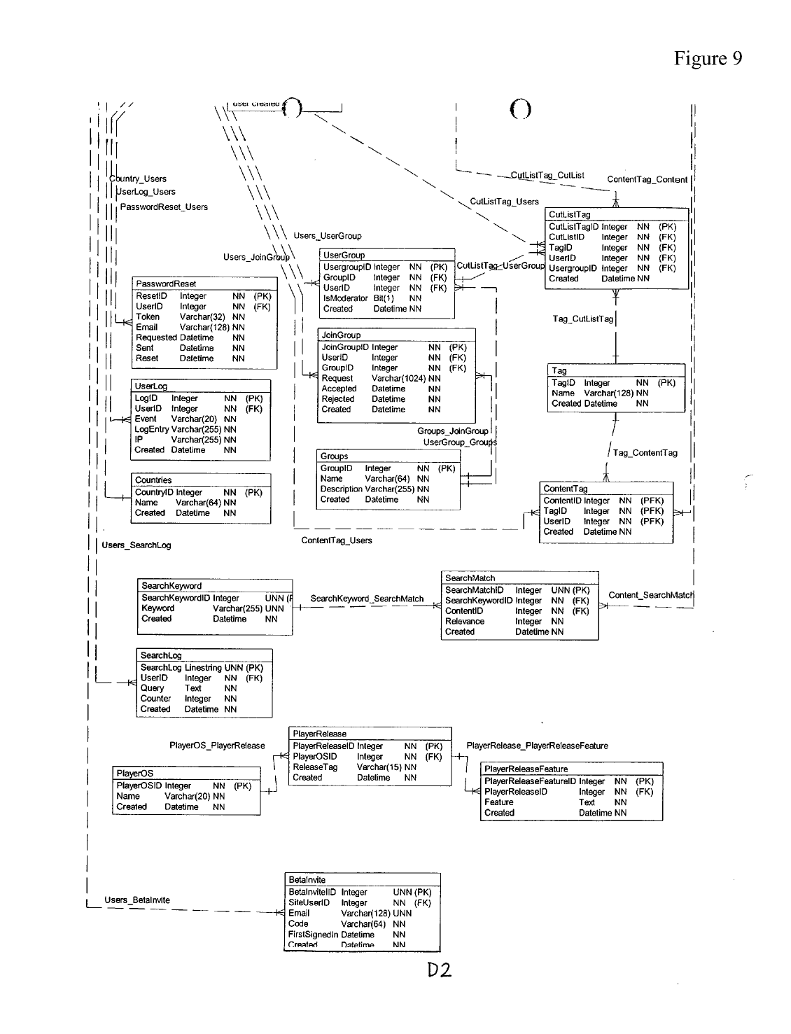

FIG. 8 shows the entity relationship diagram utilized by an embodiment of the cutlist host, for example a website. FIG. 8 shows the content table accessing the cutlist table in the center of the diagram. The cutlist table includes a CutListID or unique key identifier for each cutlist. The cutlist itself is implemented in the embodiment of the invention via XML which is stored as a BLOB. The cutlist XML includes any mashups or cuts that make up the cutlist. The mashups and cuts may be stored on the cutlist host or locally for local enabled embodiments that do not rely on the website for cutlists. FIG. 9 shows the user groups and search tables along with other tables utilized to store information related to the player and its environment. Any other type of data structure may be utilized so long as it refers to external videos and cutlist elements that are utilized to modify the video during playback without hosting the video on the cutlist host.

Although the embodiment shown in FIGS. 8 and 9 utilize XML to store the cutlist, any other method of storing a cutlist is in keeping with the spirit of the invention including storing the cutlist in a data structure separate from a database. XML that implements the cutlist may include the following elements or any other constructs:

```
<cutlist>
  <externalVideo>http://www.youtube.com/watch?v=C4kxS1ksqtw
  </externalVideo>
  <mashup><sound>http://www.cutlistHost.../cutID=XYYSDY</sound>
      <start> “0:07.0”</start> <end> “0:105”</end>
      </mashup>
  <cut><start> “0:08.0”</start>
    <end>“0:110”</end></cut>
</cutlist>
```

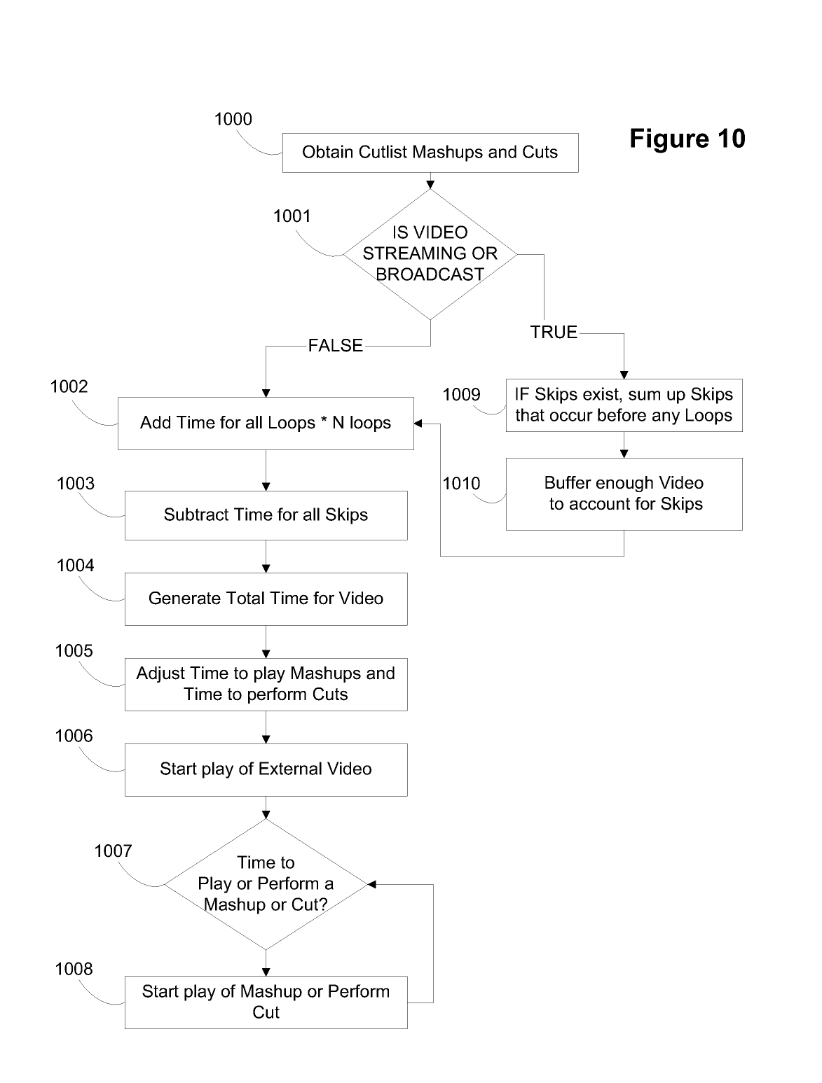

FIG. 10 shows an embodiment of the method of the playing process for combining an external video source with a cutlist. One embodiment of the invention obtains the mashups and cuts from a cutlist at 1000. For example, an XML embodiment parses the cutlist XML and makes of list of mashups and cuts. If the external video source is a streaming or broadcast type that is not downloaded or local before playing as determined at 1001, then the time for all loops is added at 1002 and the time for all skips is subtracted at 1003 to generate the total time of the modified video duration at 1004. For embodiments that do not precalculate the real time in which to play mashups and perform cuts, the time of the mashups and cuts obtained from the cutlist are adjusted to account for the real time of the event to occur at 1005. The external video is played at 1006 and if it is time to play a mashup or perform a cut at 1007 then the mashup or cut is played or performed at 1008.

For streaming and broadcast videos skips and loops may necessitate the buffering of video to account for any dead time that would occur if the video is skipped without having the “skipped-to” video portion at hand. If the cutlist has any skips as per 1009, then the durations of the skips are summed to the next loop. The difference in time between any loop occurring before a skip allows for a lessening of the buffering delay. For loops that occur before skips, where the loops take more total time than the skips, the broadcast video may be played immediately. The video is buffered by the calculated amount at 1010 and processing continues at 1002 as for rapidly available video or local video would occur. In addition, since the looped scene may be looped a configurable number of times, the number of times that the loop is to be viewed according to the cutlist is multiplied by the length of the loop to obtain the loop value. Again, if the loop value (taking into account the number of loops to view) is equal to the length of the skips that follow it, then the video may start immediately without buffering. If skips precede any loops in the cutlist, then for broadcast or streaming video, the video is buffered first for the sum of time of the skips before any loops. Alternatively, the video may be buffered for the sum of the skips for a simplified embodiments, however when the video also contains loops, this time may be lessened if any loops exist before any skips. Any other method of determining the length of time to buffer video may be utilized with embodiments of the invention so long as they do not allow dead video to occur.

Alternatively, the entire video may be downloaded and played while playing mashups and skipping the cuts. For DVD embodiments, the amount of time that a DVD player takes to advance a certain amount of time is dependent upon the DVD player and speed, and hence embodiments that utilize this type of external video source may calibrate and take advantage of any hardware buffering local to the DVD player (or computer memory coupled with a DVD player) to buffer enough data to allow for seamless skipping and looping.

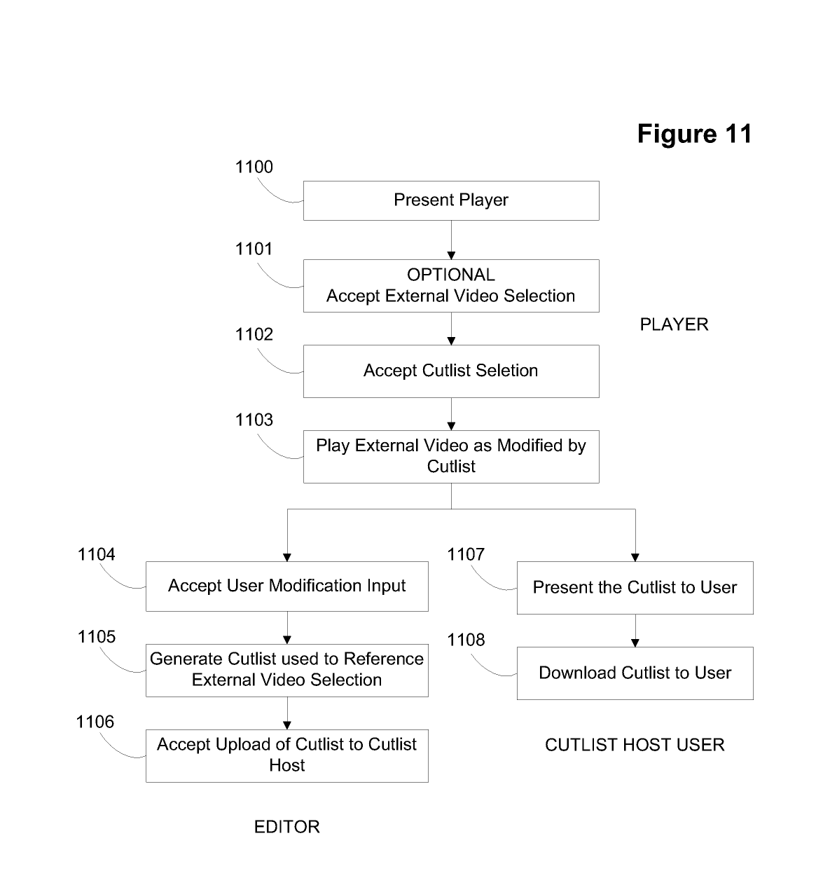

FIG. 11 shows an embodiment of the method of the system for playing, editing and accessing cutlists. Processing starts at 1100 by presenting the player. As per FIG. 1, the player may execute on any type of device associated with a video display that is capable of executing computer executable code. Optionally, the user may accept an external video selection at 1101. If the cutlist accepted by the system at 1102 does not include a reference to the external video, then this step may occur. For example, if playing a cutlist, the cutlist may refer to the external video, however, if the cutlist is being created, the external video associated with the cutlist is accepted at 1101. The system accepts a cutlist at 1102, meaning that the user may either choose a cutlist or create one for example or in any other way designate the cutlist to utilize associated with an external video source. The external video is played as modified by the cutlist at 1103. Steps 1100-1103 are generally related to a “player user” although an editor user may also utilize these steps.

Step 1104 allows for a user modification input such as a mashup or cut. The mashup and cut inputs allow for designating the particular effect and metadata associated with the effect such as start and stop time for the effect. The cutlist is generated at 1105 and in one or more embodiments utilizes XML. In other embodiments, a database or other data structure may be utilized to associate the cutlist operations with an external video source. Steps 1104-1106 are generally related to an “editor user”.

The system presents at least one cutlist to a user at 1107. The system may provide multiple methods of searching, browsing or otherwise finding desired cutlists as previously described. The system downloads a cutlist to a user at 1108 for playing in conjunction with external video on a player associated with the user. Steps 1107 and 1108 are generally related to a “cutlist host user” although an “editor user” or “player user” may also perform these steps.

While the invention herein disclosed has been described by means of specific embodiments and applications thereof, numerous modifications and variations could be made thereto by those skilled in the art without departing from the scope of the invention set forth in the claims.

What is claimed is:

1. A method for personalized cutlist creation and sharing comprising:
presenting a player to a first user;
accepting a video input selection;
accepting a cutlist selection; and,
playing a video associated with said video input selection in said player as modified via said cutlist.

2. The method of claim 1 further comprising:
accepting a user modification input from said first user via said player;
generating said cutlist associated with said video input selection wherein said cutlist includes said user modification input and wherein said cutlist includes a reference to said video input selection does not comprise said video input selection itself, and,
accepting an upload of said cutlist to a cutlist host.

3. The method of claim 1 further comprising:
presenting said cutlist to at least one second user via said cutlist host; and,
downloading said cutlist to said second user from said cutlist host.

4. The method of claim 1 further comprising:
said presenting said player further comprising presenting a player on a first computer.

5. The method of claim 1 further comprising:
said presenting said player further comprising presenting a player on a mobile computing device.

6. The method of claim 1 further comprising:
said presenting said player further comprising presenting a player integrated with a DVD player.

7. The method of claim 1 further comprising:
said presenting said player further comprising presenting a player integrated with a cable set top box, digital video recorder (DVR), video on demand (VOD) unit, video game console.

8. The method of claim 1 further comprising:
said accepting said video input selection further comprising accepting URL to an online video.

9. The method of claim 1 further comprising:
said accepting said video input selection further comprising accepting URL to a streaming video.

10. The method of claim 1 further comprising:
said accepting said video input selection further comprising accepting path to a digital media file having a video component.

11. The method of claim 1 further comprising:
said accepting said video input selection further comprising accepting path to a DVD.

12. The method of claim 1 further comprising:
said accepting said video input selection further comprising accepting a DVD in a DVD player.

13. The method of claim 1 further comprising:
said accepting said user modification input further comprising accepting a mashup wherein said mashup comprises text input.

14. The method of claim 1 further comprising:
said accepting said user modification input further comprising accepting a mashup wherein said mashup comprises audio input or an audio commentary.

15. The method of claim 1 further comprising:
said accepting said user modification input further comprising accepting a mashup wherein said mashup comprises any combination of a graphic, an avatar overlay or a second video input selection not equal to said first video input selection.

16. The method of claim 1 further comprising:
said accepting said user modification input further comprising accepting a mashup wherein said mashup comprises an advertisement.

17. The method of claim 1 further comprising:
said accepting said user modification input further comprising accepting a cut wherein said cut comprises a time window in which not to display video associated with said video input selection.

18. A personalized cutlist creation and sharing system comprising:
means for presenting a player to a first user;
means for accepting a video input selection;
means for accepting a cutlist selection; and,
means for playing a video associated with said video input selection in said player as modified via said cutlist.

19. The system of claim 18 further comprising:
means for accepting a user modification input from said first user via said player;
means for generating said cutlist associated with said video input selection wherein said cutlist includes said user modification input and wherein said cutlist includes a reference to said video input selection does not comprise said video input selection itself, and,
means for accepting an upload of said cutlist to a cutlist host.

20. The system of claim 18 further comprising:
means for presenting said cutlist to at least one second user via said cutlist host; and,
means for downloading said cutlist to said second user from said cutlist host.
